(19) United States
(12) Patent Application Publication
(10) Pub. No.: US 2025/0062588 A1
(43) Pub. Date: Feb. 20, 2025

(54) DEVICE FOR MEASURING CARRIER-ENVELOPE PHASE, STABILIZED LIGHT SOURCE, AND METHOD FOR MEASURING CARRIER-ENVELOPE PHASE

(71) Applicant: TOHOKU UNIVERSITY, Sendai-shi, Miyagi (JP)

(72) Inventors: Yohei KAWAKAMI, Sendai-shi (JP); Shinichiro IWAI, Sendai-shi (JP)

(21) Appl. No.: 18/720,428

(22) PCT Filed: Dec. 15, 2021
(86) PCT No.: PCT/JP2021/046199

§ 371 Date: Jun. 14, 2024

(51) Int. Cl. H01S 3/13; G01B 11/00; G02F 1/35; G02F 1/355; G02F 1/37; H01S 3/00

(52) U.S. Cl. CPC H01S 3/1307; G01B 11/00; G02F 1/3544; G02F 1/3551; G02F 1/37; H01S 3/0092; H01S 3/1305

(57) ABSTRACT

A device for measuring a carrier-envelope phase includes a first nonlinear optical crystal, a birefringent crystal, and a polarizing plate. The first nonlinear optical crystal produces a first Light that is a harmonic of an incident light and that has a polarization direction different from a polarization direction of the incident light. The birefringent crystal is downstream of the first nonlinear optical crystal in a light traveling direction, and a traveling speed of a light traveling along a slow axis is different from a traveling speed of the light traveling along the fast axis. The polarizing plate is downstream of the birefringent crystal in the light traveling direction, and a transmission axis of the polarizing plate is different from both the slow axis and the fast axis.

### CROSS-REFERENCE TO RELATED APPLICATIONS

This application is the U.S. National Stage entry of International Application No. PCT/JP2021/046199, filed on Dec. 15, 2021, which is hereby incorporated herein by reference in its entirety for all purposes.

### TECHNICAL FIELD

The present invention relates to a device for measuring a carrier-envelope phase, a stabilized light source, and a method for measuring a carrier-envelope phase.

### BACKGROUND ART

A very short laser pulse may include only a few light waves in one pulse. A phase of an electric field oscillation (carrier oscillation) with respect to an envelope of the laser pulse is referred to as a carrier-envelope phase. The carrier-envelope phase is an important index for characterizing the laser pulse, and plays an important role in, for example, an optical frequency comb.

For example, PTL 1 discloses that a stabilized optical frequency comb is obtained by causing harmonics having different orders to interfere with each other, detecting a carrier-envelope phase (CEO beat signal), and feeding back a result to a laser pulse light source.

For example, PTL 2 discloses that by using a quasi-phase matching device, it is possible to cause a fundamental-wave light and a wavelength-converted light (harmonic) to interfere with each other without considering a phase difference between the fundamental-wave light and the wavelength-converted light. A self-reference interference device described in PTL 2 can stabilize an optical frequency comb without being influenced by a frequency fluctuation of an interferometer.

### CITATION LIST

### Patent Literature

PTL 1: JP2014-135341A
PTL 2: JP2015-155984A

### SUMMARY OF INVENTION

### Technical Problem

A device described in PTL 1 branches harmonics having different orders by a two-branching unit 6, 6a. The CEO beat signal is detected when the branched harmonics having different orders interfere with each other in a balanced receiver 7. Respective harmonics travel along different optical paths between the two-branching unit 6, 6a and the balanced receiver 7. The carrier-envelope phase drifts due to a slight temperature fluctuation or a mechanical vibration in an optical system. When the respective harmonics travel along different optical paths, the carrier-envelope phase is likely to drift due to a slight deviation or the like in the optical system.

PTL 1 also discloses a configuration capable of reducing an optical path length difference. Meanwhile, this configuration is effective only under extremely limited conditions in which a group velocity dispersion is substantially zero and there is almost no time difference between lights having different wavelengths, and has low versatility. PTL 1 does not consider a phase difference generated between lights having different wavelengths in a nonlinear optical crystal 11. Except for a case in which a thickness of the nonlinear optical crystal 11 is sufficiently small, it is not possible to ignore the phase difference generated between the lights having different wavelengths in the nonlinear optical crystal 11. When the thickness of the nonlinear optical crystal 11 is sufficiently small, a production efficiency of the harmonic is low, and the harmonic cannot be produced unless the nonlinear optical crystal 11 is irradiated by a light having an extremely high intensity. In other words, the device described in PTL 1 cannot detect the carrier-envelope phase from a weak light and has low versatility.

In PTL 2, a special configuration referred to as the quasi-phase matching device is used to generate lights having different harmonics. The quasi-phase matching device is expensive and has low versatility.

The invention has been made in view of the problems, and an object thereof is to provide a device for measuring a carrier-envelope phase, a stabilized light source, and a method for measuring a carrier-envelope phase which can stably measure a carrier-envelope phase by preventing drift of a phase of a light that includes the carrier-envelope phase and that is emitted from a light source.

### Solution to Problem

In order to solve the problems, the invention provides the following means.

(1) A device for measuring a carrier-envelope phase according to a first aspect includes a first nonlinear optical crystal, a birefringent crystal, and a polarizing plate. The first nonlinear optical crystal produces a first light that is a harmonic of an incident light and that has a polarization direction different from a polarization direction of the incident light. The birefringent crystal is downstream of the first nonlinear optical crystal in a light traveling direction, and a traveling speed of a light traveling along a slow axis is different from a traveling speed of the light traveling along a fast axis. The polarizing plate is downstream of the birefringent crystal in the light traveling direction, and a transmission axis of the polarizing plate is different from both the slow axis and the fast axis.

(2) The device for measuring a carrier-envelope phase according to the aspect may further include a second nonlinear optical crystal. The second nonlinear optical crystal is between the first nonlinear optical crystal and the birefringent crystal in the light traveling direction. The second nonlinear optical crystal produces a second light that is a harmonic of the incident light and that has an order different from an order of the first light. The second light has a polarization direction different from the polarization direction of the first light.

(3) The device for measuring a carrier-envelope phase according to the aspect may further include a nonlinear medium. The nonlinear medium is upstream of the first nonlinear optical crystal in the light traveling direction. The nonlinear medium expands a spectrum band of a light incident on the nonlinear medium.

(4) The device for measuring a carrier-envelope phase according to the aspect may further include a laser light source configured to generate the incident light.

(5) A stabilized light source according to a second aspect includes: the device for measuring a carrier-envelope phase according to the aspect; and a feedback circuit configured to feed back a carrier-envelope phase measured by the device for measuring a carrier-envelope phase to the laser light source.

(6) A method for measuring a carrier-envelope phase according to a third aspect includes: a step of producing a first light and a second light which have different polarization directions while passing the first light and the second light through a same optical path; a step of adjusting a phase difference between the first light and the second light; and a step of changing the polarization direction of at least one of the first light and the second light to cause the first light and the second light to interfere with each other. A frequency of each of the first light and the second light is an integral multiple of a fundamental frequency.

### Advantageous Effects of Invention

The device for measuring a carrier-envelope phase, the stabilized light source, and the method for measuring a carrier-envelope phase according to the aspects can stably measure a carrier-envelope phase by preventing drift of a phase of a light that includes the carrier-envelope phase and that is emitted from a light source.

### BRIEF DESCRIPTION OF DRAWINGS

FIG. 1 is a schematic diagram of a device for measuring a carrier-envelope phase according to a first embodiment.

FIG. 2 shows an example of a laser pulse output from a laser light source.

FIG. 3 is a schematic diagram showing functions of a birefringent crystal and a polarizing plate of the device for measuring a carrier-envelope phase according to the first embodiment.

FIG. 4 is a schematic diagram of a device for measuring a carrier-envelope phase according to a second embodiment.

FIG. 5 is a schematic diagram showing functions of a birefringent crystal and a polarizing plate of the device for measuring a carrier-envelope phase according to the second embodiment.

FIG. 6 is a schematic diagram of a stabilized light source according to a third embodiment.

FIG. 7 is a schematic diagram of a device for measuring a carrier-envelope phase according to Comparative Example 1.

FIG. 8 shows a measurement result of Example 1 and Comparative Example 1.

FIG. 9 shows a measurement result of Example 1 and Comparative Example 1.

### DESCRIPTION OF EMBODIMENTS

Hereinafter, the present embodiment will be described in detail with reference to the drawings appropriately. The drawings used in the following description may show feature portions in an enlarged manner for convenience in order to make features of the invention easier to be understood, and dimensional ratios and the like of components may be different from actual ones. A material, a dimension, and the like exemplified in the following description are merely examples, and the invention is not limited thereto, and can be appropriately modified and implemented without departing from the gist of the invention.

### First Embodiment

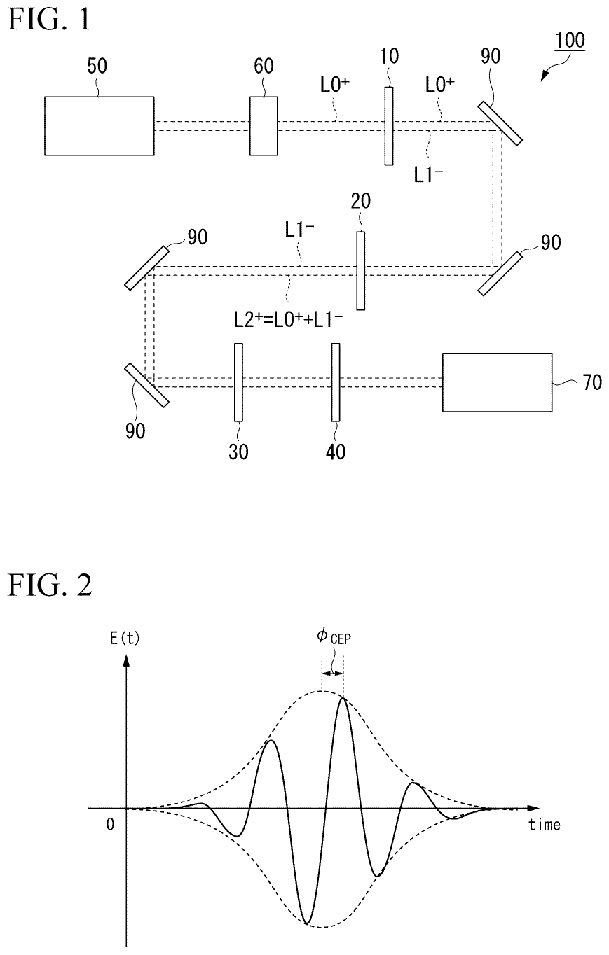

FIG. 1 is a schematic diagram of a device for measuring a carrier-envelope phase according to a first embodiment. A device for measuring a carrier-envelope phase 100 includes a first nonlinear optical crystal 10, a second nonlinear optical crystal 20, a birefringent crystal 30, a polarizing plate 40, a laser light source 50, a nonlinear medium 60, a spectrometer 70, and a plurality of mirrors 90.

The first nonlinear optical crystal 10, the second nonlinear optical crystal 20, the birefringent crystal 30, the polarizing plate 40, the nonlinear medium 60, and the plurality of mirrors 90 are on the same optical path between the laser light source 50 and the spectrometer 70. The mirror 90 is provided at any position and changes a light traveling direction.

The laser light source 50 outputs, for example, a laser pulse having a predetermined repetition frequency. For example, the laser light source 50 emits a laser pulse having a wavelength of 1.7 μm.

FIG. 2 shows an example of the laser pulse output from the laser light source 50. FIG. 2 is a time waveform of an electric field of the laser pulse. The time waveform of the electric field is expressed by E(t)=E₀(t)cos(ωt−ω_{EP}). A carrier-envelope phase ω_{CEP} is a relative phase between an envelope E₀(t) and a carrier vibration cos(ωt−ω_{CEP}). When the carrier-envelope phase (CEP deviates by half a period (π) of a light, a sign of a maximum electric field amplitude changes.

The nonlinear medium 60 is downstream of the laser light source 50 in the light traveling direction. The light output from the laser light source 50 is incident on the nonlinear medium 60. The nonlinear medium 60 may be omitted.

The nonlinear medium 60 broadens the laser pulse and expands a spectrum band. By expanding the spectrum band of the laser pulse by the nonlinear medium 60, lights having different wavelengths to be described later (for example, a second harmonic and a third harmonic) are likely to interfere with each other. The nonlinear medium 60 is, for example, a photonic crystal. The photonic crystal may be, for example, a quartz photonic crystal fiber, an illuminated photonic crystal fiber, or a highly nonlinear fiber.

The first nonlinear optical crystal 10 is downstream of the nonlinear medium 60 in the light traveling direction. The first nonlinear optical crystal 10 produces a second-order nonlinear optical effect. The first nonlinear optical crystal 10 performs phase matching of type I. When the same photoelectric field for polarization acts twice in a second-order process, the first nonlinear optical crystal 10 produces a polarized light perpendicular to an incident light. A type of the nonlinear optical crystal can be adjusted by adjusting an angle between the incident light and a crystal axis.

The first nonlinear optical crystal 10 produces a first light L1⁻ that is a harmonic of an incident light L0⁺. The first light L1⁻ is, for example, a second harmonic of the incident light L0⁺. The first light L1⁻ has a polarization direction different from that of the incident light L0⁺. The polarization direction of the first light L1⁻ and the polarization direction of the incident light L0⁺ are, for example, orthogonal to each other. A part of the incident light L0⁺ and the first light L1⁻ are emitted from the first nonlinear optical crystal 10. Since the incident light L0⁺ and the first light L1⁻ have different polarization directions, the incident light L0⁺ and the first light L1⁻ do not greatly influence each other.

The first nonlinear optical crystal 10 is, for example, β-barium borate (β-BBO), potassium dihydrogen phosphate (KDP), potassium dideuterium phosphate (DKDP), lithium triborate (LBO), and cesium lithium borate (CLBO).

A thickness of the first nonlinear optical crystal 10 is, for example, 50 μm. Since the first nonlinear optical crystal 10 has a necessarily sufficient thickness, it is possible to produce a harmonic having a sufficient intensity while securing a necessary spectral width.

The second nonlinear optical crystal 20 is downstream of the first nonlinear optical crystal 10 in the light traveling direction. The second nonlinear optical crystal 20 is between the first nonlinear optical crystal 10 and the birefringent crystal 30 in the light traveling direction. The second nonlinear optical crystal 20 produces a second-order nonlinear optical effect. The second nonlinear optical crystal 20 performs phase matching of type II. The second nonlinear optical crystal 20 produces a polarized light parallel to the incident light L0⁺ when different polarized lights are incident.

The second nonlinear optical crystal 20 produces a second light L2⁺ that is a harmonic of the incident light L0⁺. The second nonlinear optical crystal 20 produces the second light L2⁺ based on sumset mixing of the first light L1⁻ and the incident light L0⁺. The second light L2⁺ is a harmonic having an order different from that of the first light L1⁻. The second light L2⁺ is, for example, a third harmonic of the incident light L0⁺. The second light L2⁺ has a polarization direction different from that of the first light L1⁻. The polarization direction of the second light L2⁺ and the polarization direction of the first light L1⁻ are, for example, orthogonal to each other. At least a part of the first light L1⁻ and the second light L2⁺ are emitted from the second nonlinear optical crystal 20. A part of the incident light L0⁺ may be emitted from the second nonlinear optical crystal 20. Since the first light L1⁻ and the second light L2⁺ have different polarization directions, the first light L1⁻ and the second light L2⁺ do not greatly influence each other.

The second nonlinear optical crystal 20 is, for example, β-barium borate (β-BBO), potassium dihydrogen phosphate (KDP), potassium dideuterium phosphate (DKDP), lithium triborate (LBO), and cesium lithium borate (CLBO). A type of the nonlinear optical crystal can be adjusted by adjusting an angle and a cutting direction of the crystal.

A thickness of the second nonlinear optical crystal 20 is, for example, 3 mm or more. Since the second nonlinear optical crystal 20 has a sufficient thickness, it is possible to produce a harmonic having a sufficient intensity.

The birefringent crystal 30 is downstream of the first nonlinear optical crystal 10 and the second nonlinear optical crystal 20 in the light traveling direction. The birefringent crystal 30 is between the second nonlinear optical crystal 20 and the polarizing plate 40 in the light traveling direction.

A refractive index of the birefringent crystal 30 varies depending on a vibration direction of a linearly-polarized light. Therefore, in the birefringent crystal 30, a traveling speed of a light traveling along a slow axis is different from a traveling speed of the light traveling along a fast axis. The slow axis is a vibration direction in which the light travels slowly (the refractive index is high), and the fast axis is a vibration direction in which the light travels fast (the refractive index is low).

The birefringent crystal 30 is, for example, α-BBO, magnesium fluoride (Mg₂O), quartz, rutile, or yttrium orthovanadate (YVO₄).

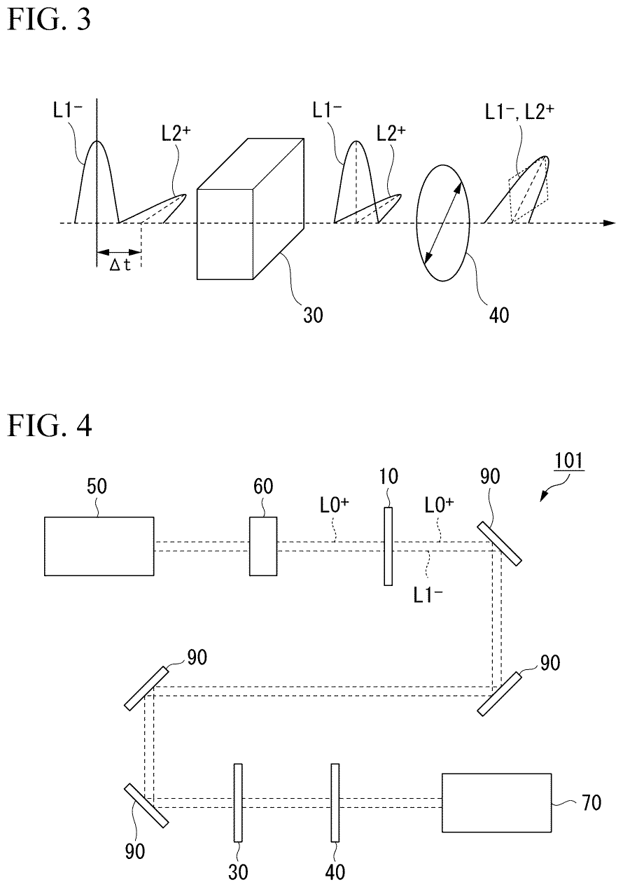

FIG. 3 is a schematic diagram showing functions of the birefringent crystal 30 and the polarizing plate 40 of the device for measuring a carrier-envelope phase 100 according to the first embodiment. There is a time difference Δt between the first light L1⁻ and the second light L2⁺ when the two lights reach the birefringent crystal 30. The time difference Δt can also be said to be a phase difference between the first light L1⁻ and the second light L2⁺. The time difference Δt occurs because a speed of the light passing through the first nonlinear optical crystal 10 and the second nonlinear optical crystal 20 varies depending on the polarization direction of the light.

The birefringent crystal 30 adjusts the time difference Δt (the phase difference). The birefringent crystal 30 reduces the time difference Δt (the phase difference) and adjusts the time difference Δt to an appropriate value for obtaining interference. For example, the time difference Δt is reduced by making the slow axis of the birefringent crystal 30 coincide with a vibration direction of a light having a relatively high traveling speed (for example, the second light L2⁺), and making the fast axis coincide with a vibration direction of a light having a relatively low traveling speed (for example, the first light L1⁻).

The polarizing plate 40 is downstream of the birefringent crystal 30 in the light traveling direction. As the polarizing plate 40, a known polarizing plate can be used. A transmission axis of the polarizing plate 40 is different from and does not coincide with both the slow axis and the fast axis of the birefringent crystal 30. For example, the transmission axis of the polarizing plate 40 is inclined by 45° with respect to each of the slow axis and the fast axis.

The polarization directions of the first light L1⁻ and the second light L2⁺ change when the first light L1⁻ and the second light L2⁺ pass through the polarizing plate 40. When the polarization directions of the first light L1⁻ and the second light L2⁺ coincide with each other, the first light L1⁻ and the second light L2⁺ interfere with each other.

The spectrometer 70 measures an interference light obtained by the interference of the first light L1⁻ and the second light L2⁺. The interference light includes a carrier-envelope phase. For example, when the first light L1⁻ is a second harmonic and the second light L2⁺ is a third harmonic, an interference intensity of the interference light between the first light L1⁻ and the second light L2⁺ satisfies the following relational formula.

$$I ( ω ) ∝ \vert {E}_{2 f} ( ω ) + {E}_{3 f} ( ω ) \vert = {I}_{2 f} ( ω ) + {I}_{3 f} ( ω ) + 2 \sqrt{{I}_{2 r} ( ω ) {I}_{3 f} ( ω )} cos \{ ωΔ t + {φ}_{2 f} + {φ}_{3 f} + {φ}_{C E P} \} \qquad [ Math . 1 ]$$

In the formula, E_{2f}(ω) is an electric field spectrum obtained by Fourier transforming a time waveform of an electric field of the second harmonic, and E_{3f}(ω) is an electric field spectrum obtained by Fourier transforming a time waveform of an electric field of the third harmonic. I(ω) is the intensity of the interference light, I_{2f}(ω) is an intensity of the second harmonic, and I_{3f}(ω) is an intensity of the third harmonic. Δt is the time difference between the second harmonic and the third harmonic. φ_{2f} is a spectrum phase obtained by Fourier transforming the second harmonic, and φ_{3f} is a spectrum phase obtained by Fourier transforming the third harmonic. ω_{CEP} is the carrier-envelope phase.

The device for measuring a carrier-envelope phase 100 can analyze the interference light and obtain the carrier-envelope phase. The first light L1⁻ and the second light L2⁺ which interfere with each other pass through the same optical path, and thus an interference condition is less likely to vary due to a temperature fluctuation or a mechanical vibration. As a result, drift of a phase of a light that includes the carrier-envelope phase and that is emitted from a light source is prevented, and the carrier-envelope phase can be stably measured.

### Second Embodiment

FIG. 4 is a schematic diagram of a device for measuring a carrier-envelope phase according to a second embodiment. A device for measuring a carrier-envelope phase 101 is different from the device for measuring a carrier-envelope phase 100 according to the first embodiment in that the second nonlinear optical crystal 20 is not provided. The components the same as those in the first embodiment are denoted by the same reference numerals, and descriptions thereof are omitted.

The birefringent crystal 30 is between the first nonlinear optical crystal 10 and the polarizing plate 40. The birefringent crystal 30 is irradiated with the incident light L0⁺ and the first light L1⁻. The first light L1⁻ has the polarization direction different from that of the incident light L0⁺.

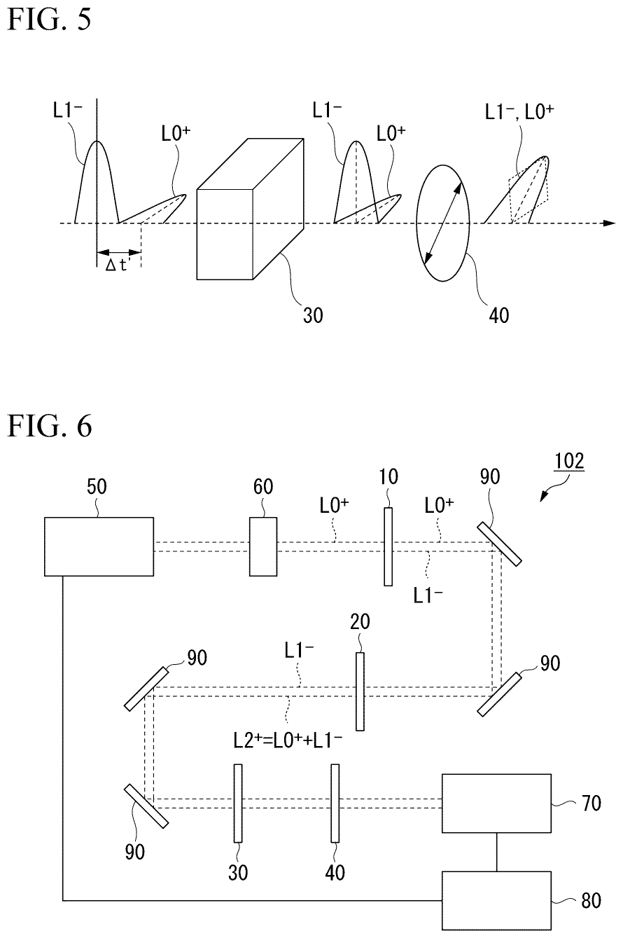

FIG. 5 is a schematic diagram showing functions of the birefringent crystal 30 and the polarizing plate 40 of the device for measuring a carrier-envelope phase 101 according to the second embodiment. FIG. 5 is different from FIG. 3 in that the second light L2⁺ is replaced with the incident light L0⁺.

There is a time difference Δt′ between the incident light L0⁺ and the first light L1⁻ when the two lights reach the birefringent crystal 30. The time difference Δt′ can also be said to be a phase difference between the incident light L0⁺ and the first light L1⁻. The time difference Δt′ occurs because a speed of the light passing through the first nonlinear optical crystal 10 varies depending on the polarization direction of the light.

The birefringent crystal 30 adjusts the time difference Δt′ (the phase difference). The birefringent crystal 30 reduces the time difference Δt′ (the phase difference) and adjusts the time difference Δt′ to an appropriate value for obtaining interference.

The polarization directions of the incident light L0⁺ and the first light L1⁻ change when the incident light L0⁺ and the first light L1⁻ pass through the polarizing plate 40. When the polarization directions of the incident light L0⁺ and the first light L1⁻ coincide with each other, the incident light L0⁺ and the first light L1⁻ interfere with each other. An interference light of these lights also includes a carrier-envelope phase.

The device for measuring a carrier-envelope phase 101 can analyze the interference light and obtain the carrier-envelope phase. The incident light L0⁺ and the first light L1⁻ which interfere with each other pass through the same optical path, the interference condition is less likely to vary due to a temperature fluctuation or a mechanical vibration. As a result, drift of a phase of a light that includes the carrier-envelope phase and that is emitted from the light source is prevented, and the carrier-envelope phase can be stably measured.

### Third Embodiment

FIG. 6 is a schematic diagram of a stabilized light source according to a third embodiment. A stabilized light source 102 according to the third embodiment includes the device for measuring a carrier-envelope phase 100 and a feedback circuit 80. The stabilized light source 102 is different from the device for measuring a carrier-envelope phase 100 in that the stabilized light source 102 further includes the feedback circuit 80. The components the same as those in the first embodiment are denoted by the same reference numerals, and descriptions thereof are omitted.

The feedback circuit 80 receives information on a carrier-envelope phase from the spectrometer 70 and feeds back the information to the laser light source 50.

The feedback circuit 80 includes, for example, a processor such as a CPU and a memory. The feedback circuit 80 operates when the processor executes a program. The processor instructs an operation of receiving the information on the carrier-envelope phase from the spectrometer 70 and an operation of adjusting the laser light source 50 based on the information on the carrier-envelope phase. The memory records data of the carrier-envelope phase and the program. The feedback circuit 80 controls, for example, a wavelength of the incident light L0⁺ output from the laser light source 50.

As described above, the devices for measuring a carrier-envelope phase according to the first embodiment and the second embodiment can prevent the drift of the phase of the light that includes the carrier-envelope phase and that is emitted from the light source. The drift of the phase occurs due to the temperature fluctuation or the mechanical vibration. Meanwhile, it is difficult to totally eliminate the drift of the phase of the light that includes the carrier-envelope phase and that is emitted from the light source. For example, the phase of the light that includes the carrier-envelope phase and that is emitted from the light source may drift due to an unintended vibration or the like. The stabilized light source 102 can stabilize the laser light by feeding back a result of the carrier-envelope phase by the feedback circuit 80.

Heretofore, the first embodiment to the third embodiment have been described to exemplify examples of the device for measuring a carrier-envelope phase and the stabilized light source. However, the invention is not limited to the embodiments, and can be modified without departing from the gist of the invention.

For example, although the case in which one or two nonlinear optical crystals are provided on the optical path has been exemplified, three or more nonlinear optical crystals may be provided on the optical path. In this case, the two interfering lights are higher-order harmonics. The two interfering lights only need to be in a relation in which a frequency of each light is an integer multiple of a fundamental frequency.

Each of the devices for measuring a carrier-envelope phase and the stabilized light source may include a filter on the optical path. For example, the device for measuring a carrier-envelope phase 100 according to the first embodiment may include, between the second nonlinear optical crystal 20 and the spectrometer 70, a filter that cuts the incident light L0⁺.

### Fourth Embodiment

A method for measuring a carrier-envelope phase according to a fourth embodiment includes a first step, a second step, and a third step.

The first step is a step of producing a first light and a second light which have different polarization directions while passing the first light and the second light through the same optical path. A frequency of each of the first light and the second light is an integral multiple of a fundamental frequency. The method for producing the first light and the second light is not particularly limited. For example, a harmonic can be produced by passing a light through a nonlinear optical crystal. For another example, a fourth harmonic whose frequency is four times the fundamental frequency may be produced by multiplying a second harmonic whose frequency is twice the fundamental frequency.

The second step is a step of adjusting a phase difference between the first light and the second light. When a time difference between the first light and the second light is too large, the first light and the second light are less likely to interfere with each other. In the second step, the phase difference between the first light and the second light is reduced, and preferably is adjusted to an appropriate value for obtaining interference. A method for adjusting the phase difference between these lights is not particularly limited. For example, the phase difference between the first light and the second light can be adjusted by passing the first light and the second light through a birefringent crystal.

The third step is a step of changing a polarization direction of at least one of the first light and the second light to cause the first light and the second light to interfere with each other. The means for changing the polarization direction of the light is not particularly limited, and for example, a polarizing plate is used.

An interference light of the first light and the second light includes a carrier-envelope phase. The method for measuring a carrier-envelope phase according to the fourth embodiment can obtain the carrier-envelope phase by analyzing the interference light. Since both the first light and the second light are produced in the same optical path, it is possible to prevent a change in interference condition and to prevent drift of a phase of a light that includes the carrier-envelope phase and that is emitted from the light source. The change in interference condition and the drift of the phase occur due to a temperature fluctuation or a mechanical vibration.

### EXAMPLES

### Example 1

In Example 1, the carrier-envelope phase was measured using the device for measuring a carrier-envelope phase shown in FIG. 1.

The laser pulse output from the laser light source 50 had a center wavelength of 1.7 μm and a pulse width of 6 femtoseconds. As the first nonlinear optical crystal 10, β-BBO of type I having a thickness of 50 μm was used. The first nonlinear optical crystal 10 produces a second harmonic. As the second nonlinear optical crystal 20, β-BBO of type II having a thickness of 3 mm was used. The second nonlinear optical crystal 20 produces a third harmonic.

As the birefringent crystal 30, α-BBO having a thickness of 1 mm was used. The slow axis of the birefringent crystal 30 was set to coincide with a vibration direction of the second harmonic. The fast axis of the birefringent crystal 30 was set to coincide with a vibration direction of the third harmonic.

The transmission axis of the polarizing plate 40 was inclined by 45° with respect to the slow axis and the fast axis of the birefringent crystal 30.

The interference light of the second harmonic and the third harmonic and the change in carrier-envelope phase over time were measured by the spectrometer 70.

### Comparative Example 1

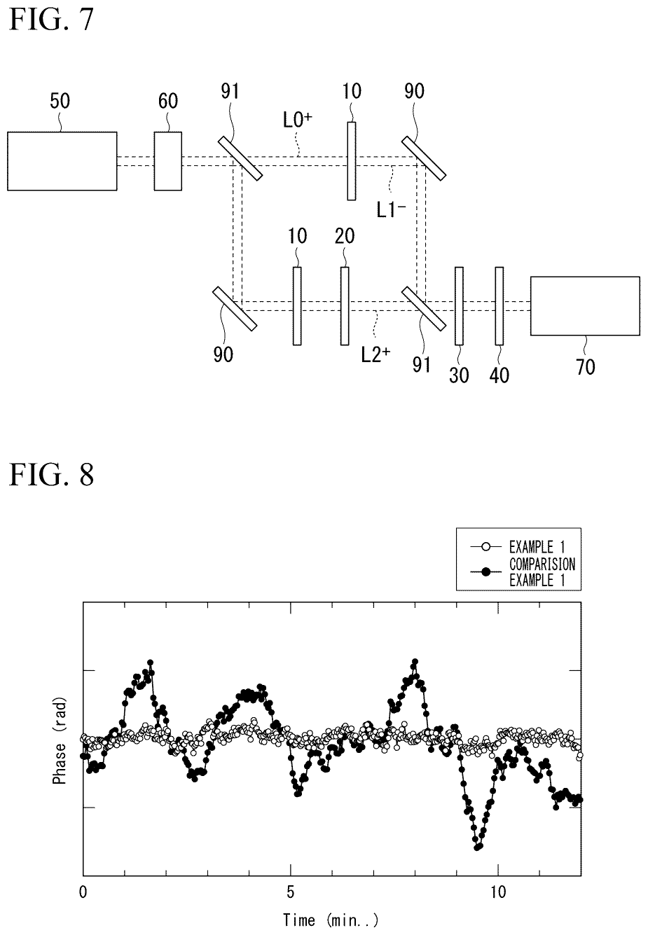

In Comparative Example 1, the carrier-envelope phase was measured using a device for measuring a carrier-envelope phase shown in FIG. 7.

Comparative Example 1 was different from Example 1 only in an arrangement of each component, and was the same as Example 1 in a specific structure of each component. In Comparative Example 1, some of the mirrors 90 are replaced with dichroic mirrors 91. In Comparative Example 1, the interference light of the second harmonic and the third harmonic and the change in carrier-envelope phase over time were also measured by the spectrometer 70.

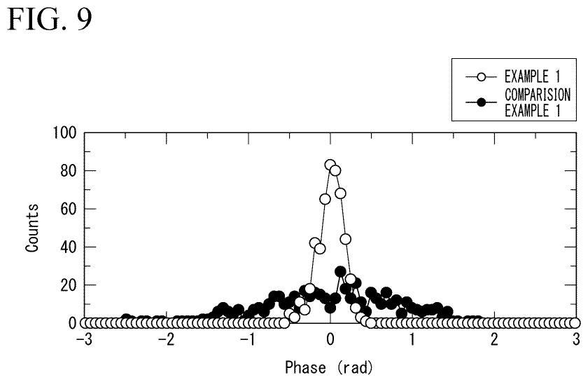

FIGS. 8 and 9 show measurement results of Example 1 and Comparative Example 1. In FIG. 8, a horizontal axis represents the time, and a vertical axis represents the carrier-envelope phase. In FIG. 9, a horizontal axis represents the carrier-envelope phase, and a vertical axis represents a count number. FIG. 9 is a graph of the count number of the carrier-envelope phase measured in FIG. 8.

As shown in FIG. 8, in Comparative Example 1, the carrier-envelope phase varies over time and is not stable. In contrast, in Example 1, the carrier-envelope phase is stabilized near zero. As shown in FIG. 9, as confirmed by the count number, in Example 1, the phase of the light that includes the carrier-envelope phase and that is emitted from the light source is constant, and a peak exists near zero, whereas in Comparative Example 1, the phase of the light that includes the carrier-envelope phase and that is emitted from the light source is not stable, and a peak is broad. This is believed to be because, in the configuration of Comparative Example 1, an optical path along which the light propagates in the second harmonic is different from an optical path along which the light propagates in the third harmonic. In other words, by making the optical path along which the second harmonic propagates the same as the optical path along which the third harmonic propagates, the phase of the light that includes the carrier-envelope phase and that is emitted from the light source is stabilized.

### REFERENCE SIGNS LIST

10: first nonlinear optical crystal
20: second nonlinear optical crystal
30: birefringent crystal
40: polarizing plate
50: laser light source
60: nonlinear medium
70: spectrometer
80: feedback circuit
90: mirror
91: dichroic mirror
100, 101: device for measuring a carrier-envelope
phase
102: stabilized light source
L0⁺: incident light
L1⁻: first light
L2⁺: second light

1. A device for measuring a carrier-envelope phase, comprising:
a first nonlinear optical crystal;
a birefringent crystal; and
a polarizing plate, wherein
the first nonlinear optical crystal produces a first light that is a harmonic of an incident light and that has a polarization direction different from a polarization direction of the incident light,
the birefringent crystal is downstream of the first nonlinear optical crystal in a light traveling direction, and a traveling speed of a light traveling along a slow axis is different from a traveling speed of the light traveling along a fast axis, and
the polarizing plate is downstream of the birefringent crystal in the light traveling direction, and a transmission axis of the polarizing plate is different from both the slow axis and the fast axis.

2. The device for measuring a carrier-envelope phase according to claim 1, further comprising:
a second nonlinear optical crystal, wherein
the second nonlinear optical crystal is between the first nonlinear optical crystal and the birefringent crystal in the light traveling direction,
the second nonlinear optical crystal produces a second light that is a harmonic of the incident light and that has an order different from an order of the first light, and
the second light has a polarization direction different from the polarization direction of the first light.

3. The device for measuring a carrier-envelope phase according to claim 1, further comprising:
a nonlinear medium, wherein
the nonlinear medium is upstream of the first nonlinear optical crystal in the light traveling direction, and
the nonlinear medium expands a spectrum band of a light incident on the nonlinear medium.

4. The device for measuring a carrier-envelope phase according to claim 1, further comprising:
a laser light source configured to generate the incident light.

5. A stabilized light source comprising:
the device for measuring a carrier-envelope phase according to claim 4; and
a feedback circuit configured to feed back a carrier-envelope phase measured by the device for measuring a carrier-envelope phase to the laser light source.

6. A method for measuring a carrier-envelope phase, comprising:
a step of producing a first light and a second light which have different polarization directions while passing the first light and the second light through a same optical path;
a step of adjusting a phase difference between the first light and the second light; and
a step of changing the polarization direction of at least one of the first light and the second light to cause the first light and the second light to interfere with each other, wherein
a frequency of each of the first light and the second light is an integral multiple of a fundamental frequency.
